(19) United States
(12) Patent Application Publication
(10) Pub. No.: US 2012/0139808 A1
(43) Pub. Date: Jun. 7, 2012

(54) ANTENNA FOR GLOBAL POSITIONING SYSTEM

(75) Inventors: Seung-Woo SHIN, Seoul (KR); Seong-Cheol LIM, Seoul (KR); Jong-Wook ZEONG, Seoul (KR); Byung-Tae YOON, Suwon-si (KR); Jin-Soo PARK, Suwon-si (KR)

(73) Assignee: SAMSUNG ELECTRONICS CO. LTD., Suwon-si (KR)

(21) Appl. No.: 13/304,504

(22) Filed: Nov. 25, 2011

(30) Foreign Application Priority Data
Dec. 1, 2010 (KR) 10-2010-0121116

(51) Int. Cl. H01Q 1/52

(52) U.S. Cl. 343/841

(57) ABSTRACT

A Global Positioning System (GPS) antenna apparatus in a wireless communication device is provided. The GPS antenna apparatus includes a GPS antenna radiator and at least one blocking layer. The GPS antenna radiator receives a GPS signal. The at least one blocking layer is installed proximate to the GPS antenna radiator so as to block an external noise introduced to the GPS antenna radiator.

### PRIORITY

This application claims the benefit under 35 U.S.C. §119(a) of a Korean patent application filed in the Korean Intellectual Property Office on Dec. 1, 2010 and assigned Serial No. 10-2010-0121116, the entire disclosure of which is hereby incorporated by reference.

### BACKGROUND OF THE INVENTION

1. Field of the Invention

The present invention relates to an antenna apparatus for a Global Positioning System (GPS). More particularly, the present invention relates to a GPS antenna apparatus for blocking an external noise.

2. Description of the Related Art

A Global Positioning System (GPS) system is a position determining system capable of determining a current position of a GPS receiver via a GPS signal (satellite information) received from a GPS satellite. Since the GPS signal is weaker than other Radio Frequency (RF) signals, it is vulnerable to external noise and interference. For example, the GPS signal is vulnerable to a multi-path signal and a jamming signal.

FIGS. 1A and 1B illustrate noise introduced to a GPS antenna apparatus according to the related art.

More specifically, FIG. 1A illustrates a structure in which a multi-path signal is introduced, and FIG. 1B illustrates a structure in which a jamming signal is introduced.

Referring to FIG. 1A, a GPS antenna apparatus of a GPS receiver receives not only a GPS signal but also a multi-path signal generated by an obstacle. Accordingly, the GPS receiver cannot determine an accurate GPS signal due to a multi-path signal.

Referring to FIG. 1B, a GPS antenna apparatus of a GPS receiver receives both a GPS signal and a jamming signal introduced from a side and a rear side of the GPS receiver. Accordingly, the GPS receiver cannot determine an accurate GPS signal due to the jamming signal. In a case where a GPS receiver cannot determine an accurate GPS signal due to external noise, the GPS receiver may produce incorrect position information estimated via the inaccurate GPS signal.

FIG. 2 illustrates a case where an error is generated in position information of a GPS receiver due to a multi-path signal according to the related art.

Referring to FIG. 2, when a multi-path signal occurs, the GPS receiver may erroneously detect the position of itself that is inaccurate. When a GPS signal transmitted from a GPS satellite 200 is transmitted via a multi-path due to an obstacle in a signal transmission path, a GPS antenna apparatus of the GPS receiver 210 receives both the GPS signal and also a multi-path signal due to the obstacle. In such a case, the GPS receiver 210 may erroneously determine the position of the GPS receiver 210 as a point A 220 due to the multi-path signal received together with the GPS signal via the GPS antenna apparatus.

As described above, in the case where the GPS receiver erroneously detects an incorrect current position, an erroneous or incorrect clock or clock signal may be generated due to an error in a determination of a distance between the GPS receiver and the GPS satellite. In addition, the GPS receiver cannot receive a GPS signal due to an external noise and may not be able to perform a repeated lock/unlock with respect to the GPS signal or may not be able to maintain an unlock state.

### SUMMARY OF THE INVENTION

Aspects of the present invention are to address at least the above-mentioned problems and/or disadvantages and to provide at least the advantages described below. Accordingly, an aspect of the present invention is to provide a Global Positioning System (GPS) antenna apparatus for blocking noise introduced from an external source.

Another aspect of the present invention is to provide a GPS antenna apparatus for receiving a GPS signal from a front side of the GPS antenna apparatus by blocking external noise introduced from a side and a rear side of the GPS antenna apparatus.

Another aspect of the present invention is to provide a GPS antenna apparatus including a cavity type can having at least one sealed lower portion for blocking noise introduced from an external source, wherein the cavity type may be disposed proximate to a GPS antenna radiator of the GPS antenna apparatus.

In accordance with an aspect of the present invention, a wireless communication device including a GPS antenna apparatus is provided. The GPS antenna apparatus includes a GPS antenna radiator installed at an outer side of the wireless communication device, and at least one blocking layer installed so as to enclose the GPS antenna radiator and for blocking an external noise introduced to the GPS antenna radiator.

In accordance with another aspect of the present invention, a GPS antenna apparatus for a wireless communication device is provided. The apparatus includes a GPS antenna radiator installed at an outer side of the wireless communication device, and a plurality of blocking layers installed proximate to the GPS antenna radiator so as to enclose the GPS antenna radiator and for blocking an external noise introduced to the GPS antenna radiator.

Other aspects, advantages, and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features, and advantages of certain exemplary embodiments of the present invention will be more apparent from the following description taken in conjunction with the accompanying drawings, in which:

FIGS. 1A and 1B illustrate a noise introduced to a conventional Global Positioning System (GPS) antenna apparatus according to the related art;

FIG. 2 illustrates a case where an error is generated in position information of a GPS transmitter due to a multi-path signal according to the related art;

FIGS. 3A and 3B illustrate an introduction of noise into a GPS antenna apparatus according to an exemplary embodiment of the present invention;

FIGS. 4A and 4B illustrate a GPS antenna apparatus for blocking an external noise according to an exemplary embodiment of the present invention;

FIGS. 5A and 5B illustrate a performance change depending on the size of a blocking layer in a GPS antenna apparatus according to an exemplary embodiment of the present invention;

FIG. 6 illustrates a size of a recess between blocking layers in a GPS antenna apparatus including a plurality of blocking layers according to an exemplary embodiment of the present invention; and

FIGS. 7A, 7B and 7C illustrate a performance change graph according to an exemplary embodiment of the present invention.

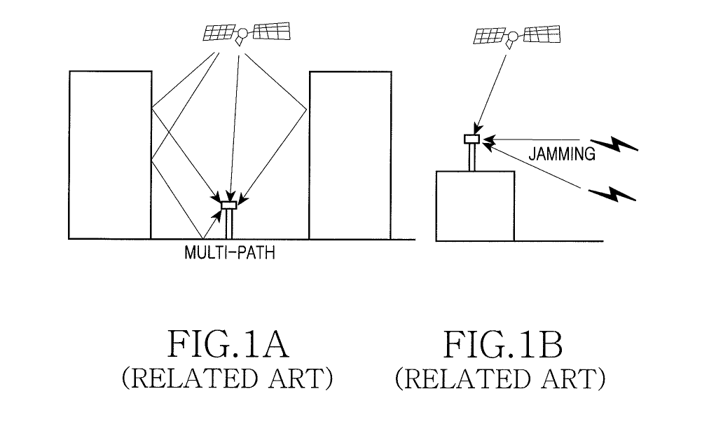

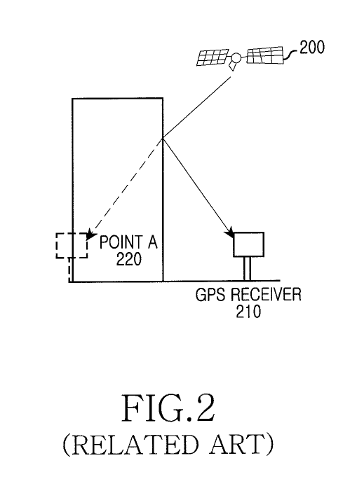

Throughout the drawings, like reference numerals will be understood to refer to like parts, components and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. Also, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

By the term “substantially” it is meant that the recited characteristic, parameter, or value need not be achieved exactly, but that deviations or variations, including for example, tolerances, measurement error, measurement accuracy limitations and other factors known to those of skill in the art, may occur in amounts that do not preclude the effect the characteristic was intended to provide.

Exemplary embodiments of the present invention provide an apparatus for blocking an external noise in a Global Positioning System (GPS) antenna apparatus. In the following description, it is assumed that an external noise may include a multi-path signal and a jamming signal.

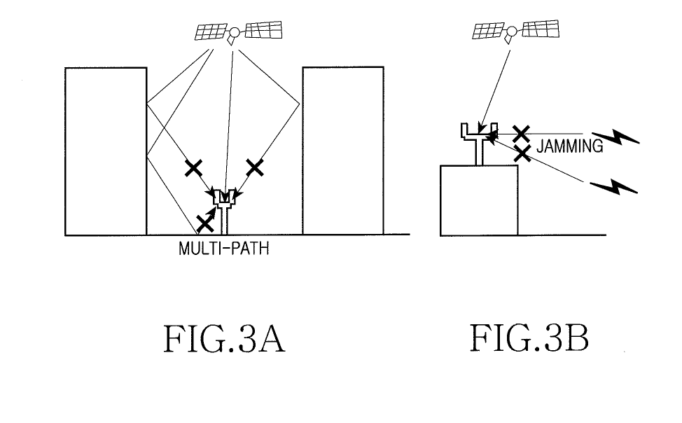

FIGS. 3A and 3B illustrate an introduction of noise into a GPS antenna apparatus according to an exemplary embodiment of the present invention.

More specifically, FIG. 3A illustrates an introduction of a multi-path signal, and FIG. 3B illustrates an introduction of a jamming signal. At least one blocking layer is installed in the neighborhood of a GPS antenna radiator to block a multi-path signal and a jamming signal introduced to a GPS antenna apparatus as illustrated in FIG. 3.

Referring to FIG. 3A, a GPS antenna apparatus includes at least one blocking layer proximate to a GPS antenna radiator of the GPS antenna apparatus in order to prevent a multi-path signal from propagating to the GPS antenna radiator. For example, although not required in all embodiments of the present invention, the at least one blocking layer may be disposed in a neighborhood of the GPS antenna radiator. Accordingly, the GPS antenna apparatus may receive a GPS signal from a front side of the GPS antenna apparatus without being influenced by an external noise that may occur from a side or a rear side of the GPS antenna apparatus.

Referring to FIG. 3B, the GPS antenna apparatus includes at least one blocking layer proximate to a GPS antenna radiator in order to prevent a jamming signal introduced from a side or a rear side of the GPS antenna apparatus from propagating to the GPS antenna radiator. Accordingly, the GPS antenna apparatus may receive a GPS signal from a front side of the GPS antenna apparatus without being influenced by an external noise occurring from the side or the rear side of the GPS antenna apparatus.

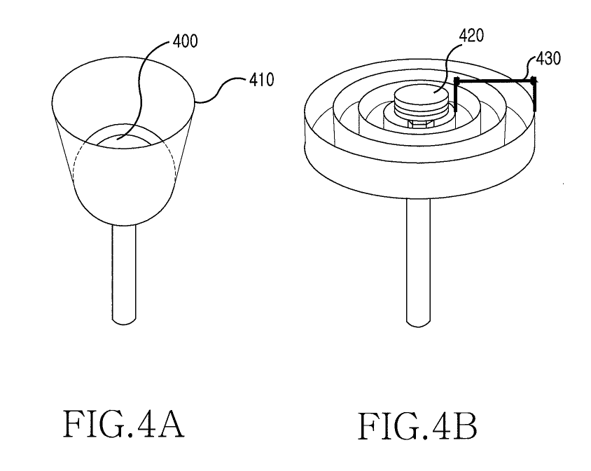

As described above, the GPS antenna apparatus includes at least one blocking layer proximate to the GPS antenna radiator in order to block propagation of a multi-path signal or a jamming signal so that the GPS antenna radiator does not receive the multi-path or the jamming signal. In the present exemplary embodiment, the blocking layer is formed as a cavity type can. The blocking layer is formed of a material that may block radio waves such as metal, and the cavity type can may be formed in a polygon such as a circular shape, an elliptical shape, or a quadrangular shape according to a shape of a cross-section of the blocking layer. However, aspects of the present invention are not limited thereto, and the blocking layer may be formed of a variety of suitable materials that may block radio waves and may be formed in a variety of suitable shapes such as a cylindrical shape as illustrated in FIG. 4.

FIGS. 4A and 4B illustrate a GPS antenna apparatus for blocking external noise according to an exemplary embodiment of the present invention.

More specifically, FIG. 4A illustrates a GPS antenna apparatus having one blocking layer, and FIG. 4B illustrates a GPS antenna apparatus having a plurality of blocking layers.

Referring to FIG. 4A, the GPS antenna apparatus includes a GPS antenna radiator 400 and one blocking layer 410. The GPS antenna radiator 400 receives a GPS signal from a GPS satellite (not shown). The blocking layer 410 blocks a multi-path signal and a jamming signal introduced from a side or a rear side of the GPS antenna radiator 400. At this point, a size of the blocking layer and a performance of the GPS antenna apparatus may have countervailing benefits. Accordingly, a width and a height of the blocking layer may be determined with consideration for a performance change according to a size change.

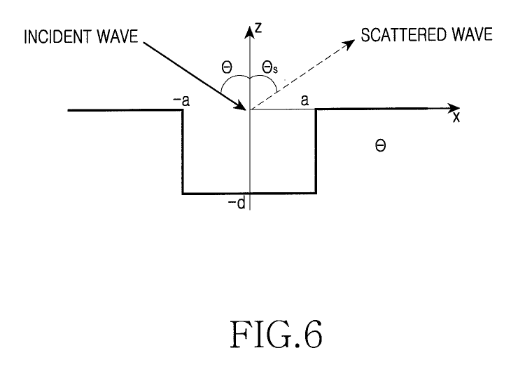

Referring to FIG. 4B, a GPS antenna apparatus includes a GPS antenna radiator 420 and a plurality of blocking layers 430. The GPS antenna radiator 420 receives a GPS signal from a GPS satellite (not shown). The blocking layers 430 block a multi-path signal or a jamming signal introduced from the side or the rear side of the GPS antenna radiator 420. A height of the blocking layers 430 closer to the GPS antenna radiator 420 is less than a height of the blocking layers 430 further from the GPS antenna radiator 420. In other words, the height of the blocking layers is reduced as they are disposed closer to the GPS antenna radiator 420. A distance between the blocking layers 420 and the heights of the blocking layers 420 as described further below with reference to FIG. 6.

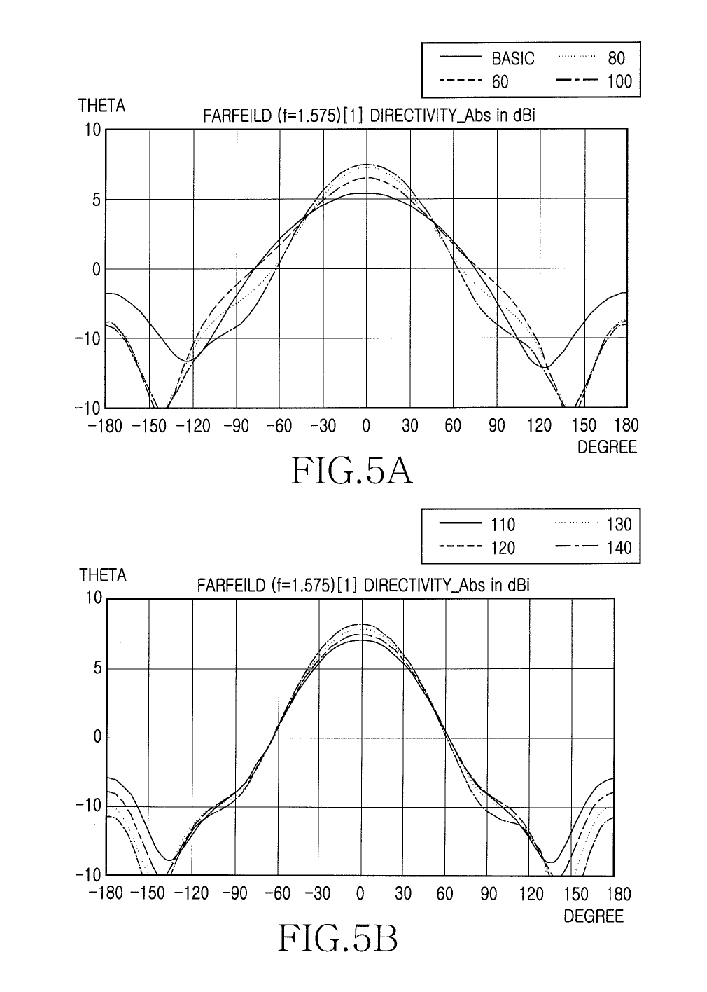

FIGS. 5A and 5B illustrate a performance change as a radiation pattern change according to a size of a blocking layer in a GPS antenna apparatus according to an exemplary embodiment of the present invention.

More specifically, FIG. 5A illustrates a change of a signal strength received by the GPS antenna radiator 400 according to a height of the blocking layer 410, and FIG. 5B illustrates a change of the signal strength received by the GPS antenna radiator 400 according to a width of the blocking layer 410.

Referring to FIG. 5A, when the height of the blocking layer 410 is changed, a rear gain of the GPS antenna radiator 400 is similar, but a front gain changes. Here, the rear gain represents a radiation characteristic between 150 to 180 degrees and between −150 to −180 degrees of a polarity of a signal.

As shown in FIG. 5A, when the height of the blocking layer 410 is changed from 60 mm to 80 mm, the front gain of the GPS antenna radiator 400 increases at 0 degrees of the polarity of the signal. In addition, when the height of the blocking layer 410 is raised from 80 mm to 100 mm, the front gain of the GPS antenna radiator 400 increases at 0 degrees of polarity. At this point, though a change in the front gain when the height of the blocking layer 410 is raised from 80 mm to 100 mm is less than a change in the front gain when the height of the blocking layer 410 is raised from 60 mm to 80 mm, the front gain itself increases.

However, when the height of the blocking layer 410 is raised to 100 mm or more, the front gain of the GPS antenna radiator 400 is not significantly or noticeably improved. Accordingly, the height of the blocking layer 410 may be set to 100 mm in order to increase the front gain. Here, the front gain represents a radiation characteristic at 0 degrees polarity for a signal.

Referring to FIG. 5B, in a case of changing a width of the blocking layer 410, when the width of the blocking layer 410 increases, the front gain of the GPS antenna radiator 400 increases constantly at 0 degrees polarity for a signal. Meanwhile, when the width of the blocking layer 410 increases, a rear gain of the GPS antenna radiator 400 reduces. Accordingly, the width of the blocking layer 410 may be set to 120 mm in order to properly maintain an increase in gain and a balance between the front gain and the rear gain.

FIG. 6 illustrates a size of a recess between blocking layers in a GPS antenna apparatus including a plurality of blocking layers according to an exemplary embodiment of the present invention.

Referring to FIG. 6, a recess between the blocking layers may be illustrated in two dimensions as having a width of 2a and a depth of d. Here, a and d, which are variables for calculating the width and the depth of the recess, may be calculated using Equation (1).

[k²−(mπ/2a)²]d²=n²π² (1)

where k is a reciprocal of a wavelength, i.e., a wave number, m and n are positive integers, a is one half of the width of the recess, and d is the depth of the recess. Here, the wavelength includes the wavelength of a GPS signal.

According to an exemplary embodiment, equation (1) may be adjusted according to a condition wherein a scattered wave becomes zero. For example, in a case of a Transverse Electric (TE) mode, Equation (1) is adjusted according to a condition that a scattered wave expressible by Equation (2) becomes zero.

$${E}_{y}^{s} ( r , {θ}_{s} ) = {{e}^{j ( {k}_{0} r - {π}^{′} 4 )} ( \frac{{k}_{0}}{2 π r} )}^{1 / 2} cos {θ}_{s} {\sum }_{m = 1}^{∞} {c}_{m} {a}_{m} sin ( {ξ}_{m} d ) \frac{{{e}^{- j {k}_{0} a sin {θ}_{s}} ( - 1 )}^{m} - {e}^{j {k}_{0} a sin {θ}_{s}}}{{( {k}_{0} sin {θ}_{s} )}^{2} - {a}_{m}^{2}} \qquad ( 2 )$$

where E^{s}_{y}(r,θₛ) is a scattered wave, k is a reciprocal of a wavelength, i.e., a wave number, m is a positive integer, a is one half of the width of the recess, and d is the depth of the recess. Here, the wavelength includes the wavelength of a GPS signal.

According to another exemplary embodiment, in a case of a Transverse Magnetic (TM) mode, Equation (1) is adjusted according to a condition that a scattered magnetic field expressible by Equation (3) becomes zero.

$${H}_{y}^{s} ( r , {θ}_{s} ) = - {{e}^{j ( {k}_{0} r - π / 4 )} ( \frac{{k}_{0}}{2 π r} )}^{1 / 2} \frac{sin {θ}_{s}}{{ɛ}_{r}} {\sum }_{m = 0}^{∞} {c}_{m} {ϛ}_{m} sin ( {ξ}_{m} d ) \frac{{{e}^{- j {k}_{0} a sin {θ}_{s}} ( - 1 )}^{m} - {e}^{j {k}_{0} a sin {θ}_{s}}}{{( {k}_{0} sin {θ}_{s} )}^{2} - {a}_{m}^{2}} \qquad ( 3 )$$

where H^{s}_{y}(r,θₛ) is a scattered magnetic field, k is a reciprocal of a wavelength, i.e., a wave number, m is a positive integer, a is one half the width of the recess, and d is the depth of the recess. Here, the wavelength includes the wavelength of a GPS signal.

In Equation (2) and Equation (3), in a case where ξₘd=±nπ approaches sin(ζₘ,d)=0, a scattered wave becomes 0. Accordingly, when reducing Equation (2) or Equation (3) by inputting a condition of ξₘd=±nπ, Equation (1) may be generated.

As described above, in a case of determining the size of the recess between the plurality of blocking layers 430, an entire size of the blocking layers installed proximate to the GPS antenna radiator may be set to have a width of 350 mm and a height of 51 mm.

Hereinafter, a performance change for a case of blocking an external noise using a blocking layer is described. In the following, the performance change is described on the assumption that a jamming signal is blocked via a blocking layer.

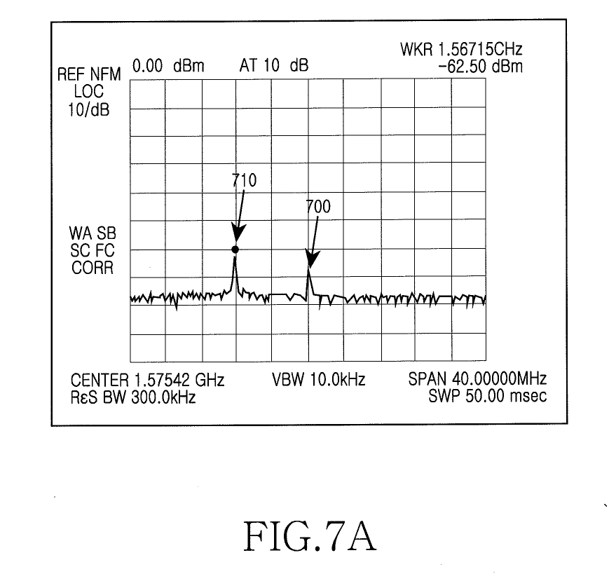

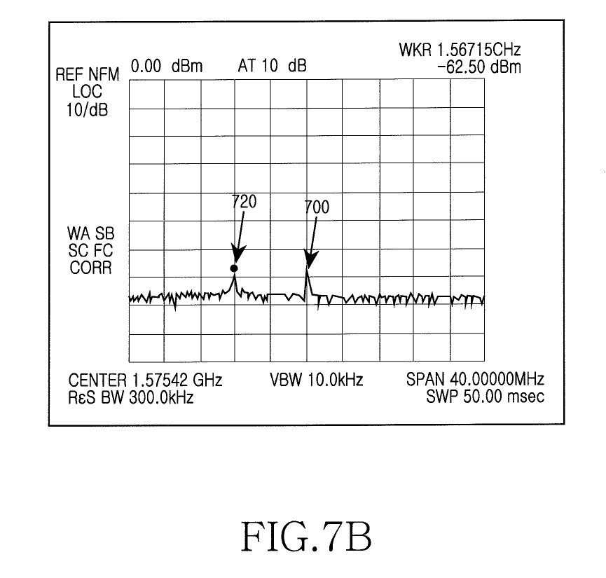

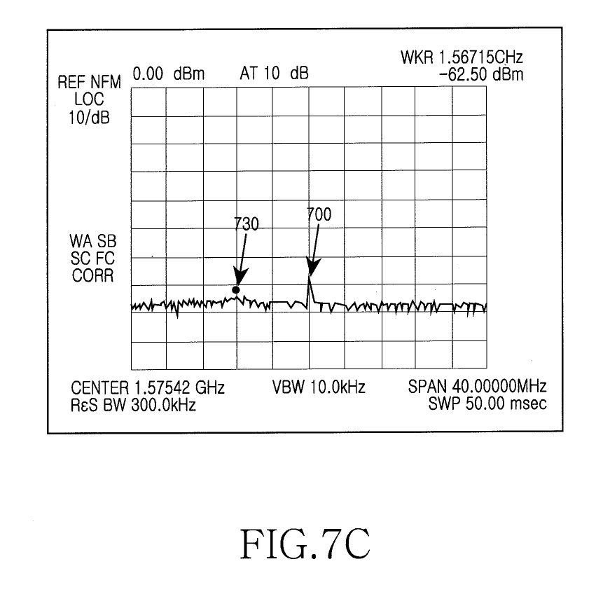

FIGS. 7A, 7B and 7C illustrate a performance change graph according to an exemplary embodiment of the present invention.

More specifically, FIG. 7A illustrates a performance for a case of not using a blocking layer, FIG. 7B illustrates a performance for a case of using one blocking layer, and FIG. 7C illustrates a performance for a case of using a plurality of blocking layers.

In a case of not using the blocking layer as illustrated in FIG. 7A, a power of a jamming signal 710 is greater than that of a signal 700 at 1575.42 MHz, which is a GPS signal band.

In a case of using one blocking layer as illustrated in FIG. 7B, a size of a jamming signal 720 is smaller than that of the jamming signal 710 illustrated in FIG. 7A. That is, a GPS antenna apparatus may block an external noise due to the jamming signal using one blocking layer.

In a case of using a plurality of blocking layers, as illustrated in FIG. 7C, a size of a jamming signal 730 is smaller than the jamming signals 710 and 720 respectively illustrated in FIGS. 7A and 7B. That is, the GPS antenna apparatus may block an external noise due to the jamming signal using the plurality of blocking layers.

As described above, a GPS antenna apparatus has an advantage of blocking an external noise introduced from the side and the rear side of the GPS antenna apparatus in order to improve a reception sensitivity or a received signal gain for a GPS signal by installing a cavity type can whose at least one lower portion is disposed proximate to a GPS antenna radiator.

While the invention has been shown and described with reference to certain exemplary embodiments thereof, it will be understood by those skilled in the art that various changes in form and details may be made therein without departing from the spirit and scope of the invention as defined by the appended claims and their equivalents.

What is claimed is:

1. A Global Positioning System (GPS) antenna apparatus for a wireless communication device, the apparatus comprising:
a GPS antenna radiator installed at an outer side of the wireless communication device; and
at least one blocking layer installed so as to enclose the GPS antenna radiator and for blocking an external noise introduced to the GPS antenna radiator.

2. The apparatus of claim 1, wherein the at least one blocking layer is formed of a material capable of blocking radio waves.

3. The apparatus of claim 1, wherein the external noise comprises at least one of a multi-path signal and a jamming signal.

4. The apparatus of claim 1, wherein the at least one blocking layer is formed to be a cavity type can whose lower portion is sealed.

5. The apparatus of claim 1, wherein the at least one blocking layer is formed in a shape of a polygon or a shape of a circle.

6. The apparatus of claim 1, wherein the at least one blocking layer is encompassed by another at least one blocking layer that is disposed further from the GPS antenna radiator than the at least one blocking layer.

7. The apparatus of claim 6, wherein a height of the at least one blocking layer is less than a height of the other at least one blocking layer.

8. The apparatus of claim 7, wherein, when the plurality of blocking layers are installed, a width of a gap between the blocking layers and a depth of the blocking layers are calculated according to the following equation:
[k²−(mπ−/2a)²]d²=n²π² where k is a reciprocal of a wavelength, m and n are positive integers, a is one half the width of a recess, and d is the depth of the recess.

9. The apparatus of claim 1, wherein when one blocking layer is installed, the at least one blocking layer has a height set to 100 mm and a width set to 120 mm.

10. The apparatus of claim 1, wherein when a plurality of blocking layers are installed, the at least one blocking layer has a height of 51 mm and a width of 350 mm.

11. A wireless communication apparatus including a Global Positioning System (GPS) antenna device, the apparatus comprising:
a GPS antenna radiator installed at an outer side of the wireless communication device; and
at least one blocking layer installed proximate to the GPS antenna radiator so as to enclose the GPS antenna radiator and for blocking an external noise introduced to the GPS antenna radiator.

12. The apparatus of claim 11, wherein the at least one blocking layer is formed of a material capable of blocking radio waves.

13. The apparatus of claim 11, wherein the external noise comprises at least one of a multi-path signal and a jamming signal.

14. The apparatus of claim 11, wherein the at least one blocking layer is formed to be a cavity type can whose lower portion is sealed.

15. The apparatus of claim 11, wherein the at least one blocking layer is formed in a shape of a polygon or a shape of a circle.

16. The apparatus of claim 11, wherein the at least one blocking layer is encompassed by another at least one blocking layer that is disposed further from the GPS antenna radiator than the at least one blocking layer.

17. The apparatus of claim 16, wherein a height of the at least one blocking layer is less than a height of the other at least one blocking layer.

18. The apparatus of claim 17, wherein, when the plurality of blocking layers are installed, a width of a gap between the blocking layers and a depth between the blocking layers are calculated using the following equation:
[k²−(mπ/2a)²]d²=n²π² where k is a reciprocal of a wavelength, m and n are positive integers, a is one half the width of a recess, and d is the depth of the recess.

19. The apparatus of claim 11, wherein at least one of the plurality of blocking layers has a height set to 100 mm and a width set to 120 mm.

20. The apparatus of claim 11, wherein, when a plurality of blocking layers are installed, the at least one blocking layer has an entire height of 51 mm and an entire width of 350 mm.
